(19) United States
(12) Patent Application Publication
(10) Pub. No.: US 2003/0127522 A1
(43) Pub. Date: Jul. 10, 2003

(54) Data card carrier and method of manufacture

(76) Inventors: Warren McKinney, Naperville, IL (US); Steve Pasek, Tinley Park, IL (US)

Correspondence Address: BLACKWELL SANDERS PEPER MARTIN LLP, 720 OLIVE STREET, SUITE 2400, ST. LOUIS, MO, 63101, US

(21) Appl. No.: 10/037,259

(22) Filed: Dec. 21, 2001

(51) Int. Cl. G06K 19/00

(52) U.S. Cl. 235/487

(57) ABSTRACT

A data card display assembly is provided for the display and marketing of data cards such as debit cards, gift cards and prepaid phone cards. The display assembly includes a display panel that can have advertising indicia on a display surface. The assembly also includes an attachment device for adhesively securing a data card to the panel. The attachment device includes a layer of reusable adhesive so that the card can be removed from the panel and replaced thereon and with removal leaves little or no adhesive residue on the card. The attachment device further includes a permanent adhesive layer that secures the attachment device to the panel.

### BACKGROUND OF INVENTION

In the past few years there has been a major growth in the sale and use of data cards such as pre-paid debit cards and credit cards. Such cards are typically sold at retail outlets and can have a pre-encoded value or may be activated at the retail outlet with a particular value as desired by the consumer. Such cards carry certain encoded data including the value, security coding, etc. Such cards can be used for the purchase of products, services or the like and can be used for such things as phone calling cards. Once the encoded value is fully used, the card no longer can be used. Such cards can be used as gift certificates or for personal use.

One of the problems with such cards is security. That is, people can take certain security information from the cards and obtain products or services therewith. Also, if a card is pre-activated then the cards may be stolen causing loss of revenues to the retail outlet. In order to alleviate the last mentioned problem, it is desired by the retail outlets to activate the card upon purchase which also allows a consumer to determine the exact value of the card. If a card is stolen before activation, the retail outlet only loses its cost of purchasing the card and the display panel the card is typically mounted on.

Many patents have been issued relating to such data cards and the assembly of the data cards with the display panels on which they are mounted. Many of these card display assemblies are complicated and expensive to manufacture requiring heavy board stock, expensive gluing and expensive manufacturing machinery to form the card display assemblies. Further, because of the large number of patents, it is often difficult to produce an assembly without the risk of infringement which assembly will also permit inexpensive manufacturing allowing ease of activation at the point of purchase. Also, at the point of purchase, the ability to expose the data encoding portion of the card which is typically a magnetic strip without taking a significant amount of time on the part of the cashier to remove the card and activate it or otherwise expose the magnetic strip for activation.

In order to reduce the costs of the card display assemblies, thinner paper stock and simpler means of applying adhesive to attach a card to a display panel are desirable. Typically, and as taught in numerous of the patents, glue is applied to the display panel and the card is then adhered to the display panel by bonding it to the display panel with the applied glue. A typical glue is a hot melt glue which permanently affixes the card to the display panel. This requires significant effort in time to remove a card from the display panel and oftentimes leaves a glue residue on the data card upon its removal then requiring effort by the consumer or the cashier to remove the adhesive residue.

The application of wet glues and some hot melt glues to paper stock can result in puckering or other distortion of the paper if the paper stock is not thick. Thus, it would be desirable to provide an assembly which permits the use of thinner paper stock for the display panel while still allowing adhesive securement of cards to display panels. It would also be desirable to have a structure that allows a card to be removed from the display panel easily, remounted thereon if desired and which leaves no adhesive residue on the card.

Thus, there is a need for an assembly of a display panel and data card which is simpler in construction, more economical to manufacture and simple to activate the card.

### SUMMARY OF INVENTION

The present invention involves the provision of an assembly including a display panel having a data card attached thereto by an attachment device. The attachment device includes a carrier having adhesive on opposite surfaces thereof. The adhesive on one surface is for attachment to the display panel while the adhesive on the other surface is for attachment of the data card to the attachment device and hence the display panel. The adhesive in contact with the data card is a temporary or reusable adhesive allowing the card to be removed and reattached to the display panel. The reusable adhesive has a lower peel strength than the adhesive bonding the attachment device to the display panel.

The present invention also involves the provision of a method of making a card display assembly comprising a data card mounted on a display panel. The method includes providing a plurality of display panels and feeding the display panels to an attachment station wherein a double sided adhesive attachment device is applied to a surface of the display panel by blowing the attachment device onto the display panel at a desired location. The panel with the attached attachment device is then fed to a card application station wherein a card is applied to each of the display panels by bonding the card to the attachment device. Pressure may be applied to the attachment device before application of the card or to the card and the attachment device to ensure proper bonding of the attachment device and card to the display panel.

### BRIEF DESCRIPTION OF DRAWINGS

FIG. 1 is a perspective view of a display assembly comprising a display panel attachment device and card with portions broken away to show details of the various parts.

FIG. 2 is a partial sectional view taken along the line 2-2, FIG. 1, with certain portions of the figure shown enlarged to better view the details thereof.

FIG. 3 is a schematic illustration of an assembly line to illustrate the method of assembling the card display assembly.

Like numbers throughout the drawings designate like or similar parts as more fully described in the below description of the invention.

### DETAILED DESCRIPTION OF THE INVENTION

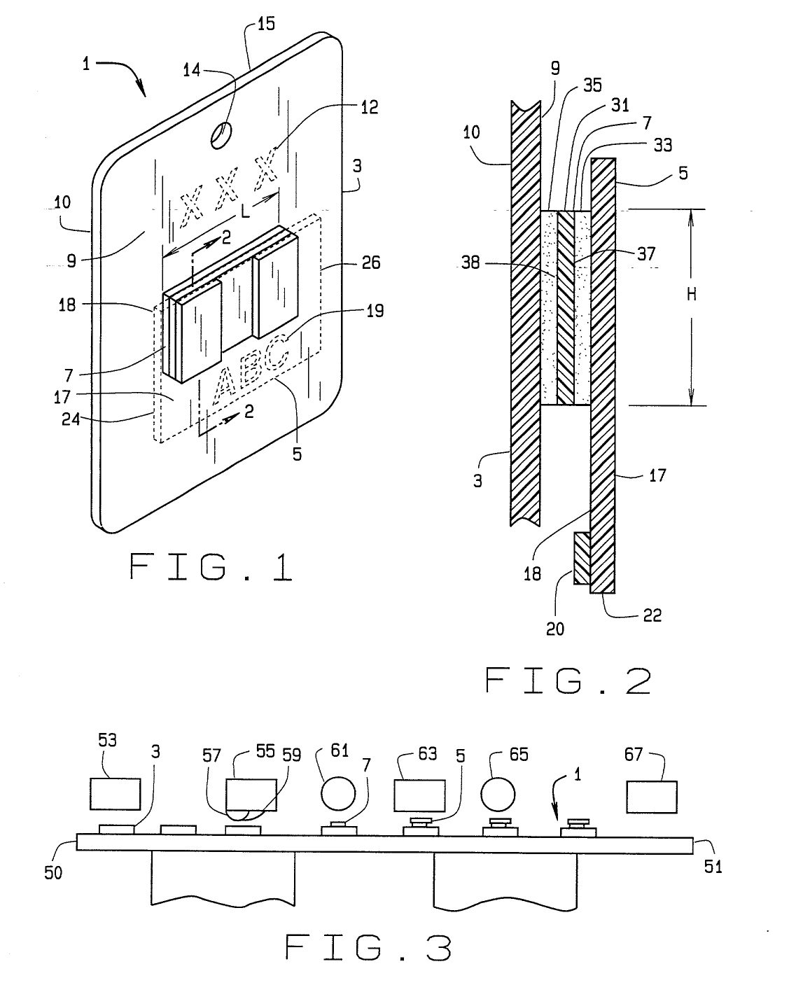

As best seen in FIG. 1, the referenced numeral 1 designates generally a card display assembly for the display and sale of data cards or other data storage devices such as CD's, mini CD's, memory cards, etc. The display assembly 1 includes a display panel 3 having removably mounted thereon a data card 5 (shown in phantom in FIG. 1). The card 5 is mounted to the display panel 3 by an attachment device 7. The attachment device 7 is adhesively bonded to both the card 5 and the display panel 3.

The display panel 3 is preferably a paper based material which can be any suitable coated or uncoated paper or paper board having a thickness in the range of between about 0.003 inches and about 0.048 inches, preferably in the range of between about 0.008 inches and about 0.30 inches and more preferably in the range of between about 0.008 inches and about 0.014 inches. The panel 3 has opposite main surfaces 9 and 10 (front and rear respectively) which in normal use are generally planar and parallel. The surface 9 is adapted for printing of indicia 12 such as advertising material, artistic graphics and/or corporate names and can be printed in color preferably multiple colors as is known in the art. Surface coatings may be applied to the surfaces 9 and 10 to enhance their appearance or to improve their endurance. Such coatings can include clay coatings, polymeric coatings, varnishes, shellacs, etc. as is known in the art. Indicia 12 may be provided as desired by the marketer or retail outlet indicating such things as corporate name, trademarks, marketing materials regarding the card. An opening 14 can be provided adjacent a top edge 15 for displaying the assembly 1 on a display device such as those using pegs and commonly referred to as peg boards.

The card 5 has front and back main surfaces 17 and 18 respectively. The card 5 is typically made from a polymeric material such as PVC. Typically the size of such debit and credit cards is on the order of 2⅛ inches by 3⅜ inches. The cards are generally rigid, i.e., do not bend under their own weight. The front surface 17 can have indicia 19 as corporate names, trademarks, marketing information, etc. printed thereon. The back surface 18 typically has a data storage device 20 such as a bar code or a magnetic strip (and herein described as a data area) which contains information about the card, its value, etc. as is well known in the art. The data area 20 is typically located adjacent a bottom edge 22 of the card 5. The surface area of a surface 17 or 18 of the card 5 is typically significantly less than the surface area of a surface 9 or 10 of the panel 3. The area of a surface 9 or 10 is generally at least four times or more larger than the surface area of a surface 17 or 18. The larger size of the display panel allows for effective marketing messages and to allow a consumer to easily locate the card while shopping. The thickness of the card is typically in the range of between about 0.015 inch to about 0.030 inch. The data area 20 generally runs between opposite ends 24 and 26 of the card 5.

The attachment device 7 includes a polymeric carrier 31 positioned between two layers of adhesive 33 and 35. The carrier 31 can be any suitable polymeric material such as polyethylene, polypropylene or vinyl. The thickness of the carrier 31 is preferably in the range of between about 0.003 inch and about 0.010 inch and more preferably in the range of between about 0.003 inch and about 0.005 inch. The carrier 31 has opposite surfaces 37 and 38 with each of the surfaces having applied thereto a layer of adhesive 33 or 35 respectively as described below. The length of the carrier 31 is preferably less than the width of the card 5 between the end edges 24 and 26. For example, the length of the carrier can be about ½ of an inch less than the width of the card. The height H of the carrier 31 is such that the adhesive can bond the card to the display panel but not adhere to the data area 20. It has been found that a height in the range of between about ½ inch and ¾ inch is acceptable while not requiring high precision location of the card 5 relative to the attachment device 7.

Adhesive is applied to each of the surfaces 37 and 38 of the attachment device 7. The adhesive layer 35 is preferably a permanent adhesive, i.e., cannot be reused to readhere. In a preferred embodiment, the entire back surface 38 of the attachment device 7 has adhesive 35 on the carrier 31 applied thereto. The adhesive 35 is preferably a permanent adhesive such as M1270 from Findley. The peel strength of the adhesive 35 to the carrier 31 and the peel strength of the adhesive 35 to the panel 3 preferably exceeds the peel strength of the adhesive 33 to the card 5. Likewise, the peel strength of the adhesive 33 on the carrier 31 also exceeds the peel strength of the adhesive 33 to the card 5. Also, the peel strength of the panel 3 is such that the card 5 will peel from the adhesive 33 before there is a failure in the material of the panel 3 to ensure that the card 5 can be removed from the attachment device 7 while allowing it to be reapplied thereto. The adhesive 33 is preferably a reusable adhesive, such as M1785 from Findley, which prevents removal of the card 5 from the attachment device 7 while allowing the attachment device 7 to remain as a monolithic structure itself and with the panel 3. Removal of the card 5, by the use of a reusable adhesive, allows a card to be removed either for reattachment or for use by the consumer while leaving little or no residue of the adhesive 33 thereon. The may be provided for the assembly process of the display assembly 1 on an elongate strip as more fully described below.

Referring now to FIG. 3, the method of manufacturing a display assembly will be described. An assembly line 50 includes a conveyor 51 adapted to move various components and the various stages of assemblies through assembly stations as hereinafter described. As seen in FIG. 3, the conveyor 51 first accepts panels 3 deposited by a depositor and magazine combination 53. The panels 3 may be indexed at given positions or automatic sensors may be provided downstream to provide for accurate depositing of the various additional components of the display assembly 1 onto the panels 3. The conveyor 51 transfers the deposited panels 3 first to an applicator station 55 operable to deposit attachment devices 7 onto the panels 3. The attachment devices 7 are fed from a roll of carrier stock 57 and are released therefrom and applied to the panel by a blower 59 as is known in the art. Pressure may be applied to the applied attachment device 7 by a pressure applying device such as a roller 61. The partially assembled display assembly 1 is then transferred to an applicator station 63 which includes a magazine for the cards 5 for the application of the card 5 to the attachment device 7. After application of the card 5, the assembly may then be transferred to a pressure applying device 65 such as a roller to apply pressure to the card to ensure its adherence to the attachment device 7. Alternatively, the pressure applying device 61 may be eliminated and only the pressure applying device 65 used. The assemblies 1 after completion are then transferred to a packaging station 67 for packaging as is known in the art. The thus completed display assemblies 1 as packaged can be then shipped to desired locations.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

1. A data storage device display assembly including:
a display panel having at least two main surfaces with one being a display surface;
a data storage device attachment device secured to said display surface, said device including a carrier strip with first and second faces, said device including first adhesive on the first face and adhered to the display surface and further including a second adhesive on the second face and facing generally the same direction that the display surface faces, said second adhesive being a reusable adhesive; and
a data storage device in contact with the second adhesive removably securing the data storage device to the panel.

2. A display assembly as set forth in claim 1 wherein the first and second adhesives include pressure sensitive adhesive.

3. A display assembly as set forth in claim 2 wherein said first adhesive is shrink resistant after application to the display panel.

4. A display assembly as set forth in claim 3 wherein said first adhesive does not require heat to effect bonding to the display panel.

5. A display assembly as set forth in claim 4 wherein the first adhesive is permanent adhesive.

6. A display assembly as set forth in claim 5 wherein the data storage device includes a data card.

7. A display assembly as set forth in claim 1 wherein the carrier strip is made of a polymeric material.

8. A display assembly as set forth in claim 1 wherein said the peel strength of the second adhesive with the data storage device is less than the peel strength of the first adhesive with the display panel.

9. A display assembly as set forth in claim 8 wherein the second adhesive was a surface area of contact an the card less than a surface area of contact of the first adhesive on the display panel.

10. A display assembly as set forth in claim 1 wherein the second adhesive is present on the carrier strip in a plurality of spots.

11. A method of making a data storage device display assembly, said method including:
providing a plurality of display panels, each said display panel having an exposed display surface;
providing an attachment device comprising a carrier with first and second surfaces and reusable adhesive on the first surface and permanent adhesive on the second surface;
bonding an attachment device to a respective display panel by bringing the permanent adhesive into contact with a respective display surface;
providing a plurality of data storage devices each having a pair of surfaces; and
bonding a data storage device to a respective display panel by bringing a said data storage device surface into contact with the reusable adhesive whereby a data storage device is releasably mounted on a respective display panel.

12. A method as set forth in claim 11 wherein the attachment device is brought to the display panel by blowing at an attaching station.

13. A method as set forth in claim 12 including feeding the attachment devices to the attaching station on an elongate carrier strip to which the attachment devices are releasably mounted.

14. A method as set forth in claim 13 wherein the data storage devices include data cards.

15. A method as set forth in claim 11 wherein the permanent adhesive has a higher peel strength with the display panel than the reusable adhesive has with the data card.
